(19) United States
(12) Patent Application Publication
(10) Pub. No.: US 2024/0359241 A1
(43) Pub. Date: Oct. 31, 2024

(54) End mill

(71) Applicant: Gühring KG, Albstadt (DE)

(72) Inventor: Jochen Gruber, Inzigkofen (DE)

(73) Assignee: Gühring KG, Albstadt (DE)

(21) Appl. No.: 18/646,233

(22) Filed: Apr. 25, 2024

(30) Foreign Application Priority Data
Apr. 27, 2023 (DE) 10 2023 110 958.8

(51) Int. Cl. B23C 5/10

(52) U.S. Cl. CPC B23C 5/10; B23C 2210/0421; B23C 2210/40

(57) ABSTRACT

An end mill cutter (1; 100) includes a shaft (10) and a cutting head (20) with a number of helically running cutting webs (50), which are spaced apart from one another by means of flutes (30). The cutting webs (50) are divided into cutting web segments (60) at least over a portion of their length by a number of divider grooves (40) running helically in the opposite direction. The cutting head (20) is divided into a shaft-side cutting step (22) and an end face-side cutting step (24) adjoining the shaft-side cutting step (22) via a transition section (23) with a cutting diameter, which is smaller with respect to the shaft-side cutting step (22).

### CROSS-REFERENCE TO RELATED APPLICATION

This application claims the benefit of German Patent Application DE 10 2023 110 958.8, filed on Apr. 27, 2023, the content of which is incorporated by reference in its entirety.

### TECHNICAL FIELD

The disclosure relates to an end mill cutter for milling layered composite materials, e.g., fiber reinforced plastics (FRP), such as carbon fiber or glass fiber reinforced plastics (CRP/GRP), as well as for stripping wires.

### BACKGROUND

Due to their multi-phase structure, fiber reinforced plastics are relatively difficult to process. When milling an FRP plate, a delamination of fiber composite layers or fiber protrusions, for example, can thus often be observed on the two plate surfaces. An economic processing of modern fiber reinforced plastics thus requires an adapted tool design, in particular in the series production, by means of which a delamination or fiber protrusions can be reliably avoided on a processed FRP component. The mentioned tools with adapted tool design include, for example, end mill cutters, which are embodied as so-called compression milling cutter, in the case of which oppositely directed axial cutting forces are generated by means of a special cutting part design. At the point where the fibers of a milled FRP material meet, which are usually created due to these cutting forces, these fibers are compressed and are lastly separated. A delamination or fiber protrusions on the two plate surfaces is prevented thereby.

An end mill cutter for milling layered composite materials, e.g., glass fibers, is known from the publication U.S. Pat. No. 9,174,287 B2, which has a shaft and a cutting head comprising a plurality of helically running main flutes with positive cutting angle and a plurality of auxiliary flutes with positive cutting angle running helically in the opposite direction, whereby the number of main flutes and the number of auxiliary flutes differ from one another. The cutting head has a constant outer diameter over its entire axial length. The end mill cutter additionally has several end cutting edges. The auxiliary flutes act as divider grooves for the main flutes and divide the main cutting edges running along the main flutes into a plurality of main cutting edge segments. An auxiliary cutting edge segment, which extends along the auxiliary flute and which is formed by forming the corresponding auxiliary flute, adjoins each main cutting edge segment on the end face. As a whole, the end mill cutter of the U.S. Pat. No. 9,174,287 B2 thus has a plurality of circumferentially cutting cutting web segments, which each contain a main cutting segment lying on the tool outer diameter and an auxiliary cutting segment lying on the tool outer diameter. Oppositely directed axial cutting forces, which can counteract a delamination during the processing of layered composite materials, can be generated due to this design.

It is a disadvantage of the end mill cutter of the U.S. Pat. No. 9,174,287 B2 that the

possible uses of the tool is limited to the milling of layered composite materials due to the special design of the cutting edges.

The publication DE 10 2019 213 976 A1 discloses a circumferentially cutting milling tool for stripping an insulating layer from a wire, which is also referred to as hairpin, with essentially rectangular cross section. The milling tool is designed as profile tool, i.e., that the effective outer contour equipped with circumferential cutting edges is adapted to the outer contour of the workpiece W to be processed. For this purpose, the cutting region equipped with circumferential cutting edges has a step, which divides the milling tool into an end face-side first section with cylindrical outer contour or enveloping surface, respectively, with a first diameter as well as a shaft-side second section, which is separated by the step, with cylindrical outer contour or enveloping surface, respectively, with a second diameter, which is larger than the first diameter. The outer contour of the step, which forms a transition from the first section to the second section, is adapted to the outer contour, in particular to the edges of the rectangular cross section, of the wire, whereby the wire has an undamaged clean surface after the stripping. The circumferential cutting edges are not interrupted and extend from an end face of the tool all the way into the shaft-side second section.

### SUMMARY

The present disclosure describes an end mill cutter, which is suitable for the milling of layer composite materials, e.g. fiber reinforced plastics (FRP), such as carbon fiber or glass fiber reinforced plastics (CRP/GRP), as well as for stripping wires, in particular so-called hairpin wires, which are used in the field of the stator windings of electrical motors and generators, and which thus offers more possible uses.

The end mill cutter comprises a shaft and a cutting head with a number of helically running cutting webs, which are spaced apart from one another by means of flutes, whereby the cutting webs are divided into cutting web segments at least over a portion of their length by a number of divider grooves running helically in the opposite direction. The cutting head is divided into a shaft-side cutting step and an end face-side cutting step adjoining the shaft-side cutting step via a transition section with a cutting diameter, which is smaller with respect to the shaft-side cutting step.

Each cutting web segment has a circumferentially cutting main cutting edge, which, viewed in the direction of extension, extends from a cutting web segment corner lying on the end face all the way to a cutting segment corner lying on the shaft side. The main cutting edge of each cutting web segment corresponds to the cutting line between the cutting surface and the back or a clearance surface of the cutting web segment, respectively. In a cross sectional view viewed in the direction of the axis of rotation of the end mill cutter, the cutting surface and the back or the clearance surface of the cutting web segment, respectively, form a cutting wedge in the manner known to the person of skill in the art.

In contrast to the end mill cutter of the U.S. Pat. No. 9,174,287 B2, the cutting head of the end mill cutter according to the invention is divided into a shaft-side cutting step and an end face-side cutting step, which adjoins the shaft-side cutting step via a transition section with a cutting diameter, which is smaller with respect to the shaft-side cutting step. Due to the cutting webs or cutting web segments form on the transition section, the transition section of the end mill cutter can be used to process and strip corners or edges of wires with a rectangular cross section. Two end mill cutters according to the invention can be used, which are arranged so that the axes of rotation thereof lie axially parallel and axially offset and the end faces of the end mill cutters point in opposite directions. The end mill cutters can be placed on opposite side surfaces of the wire, so that the transition sections of the end mill cutters can process two corners or edges of the wire lying diametrically opposite one another when the end mill cutters, which rotate about the axis of rotation thereof are moved relative to the wire. The two end mill cutters have to be positioned anew to the wire only once for a processing or stripping, respectively, of the remaining two corners or edges of the wire lying diametrically opposite one another.

It has been determined that the end mill cutter according to the invention can achieve good surface qualities during the processing of layered composite materials, e.g., CRP materials, by means of a milling by means of the end face-side cutting step and the shaft-side cutting step. Further areas of application for the end mill cutter according to the invention are the processing of plastics as well as of easily machinable, soft metal materials, for example copper or aluminum. Due to the transition section between the shaft-side cutting step and the end face-side cutting step, the end mill cutter is, on the other hand, also particularly suitable for removing or stripping, respectively, relatively soft insulating material from an in particular rectangular metal wire, so that the wire has a clean and undamaged surface after the stripping. It goes without saying that the function of the transition section is not limited to a stripping of corners or edges of a wire. For example, the transition section can also be used to mill special contours in a workpiece. The end mill cutter according to the invention thus represents a combination tool, which offers a plurality of possible uses.

In a preferred embodiment, the divider grooves taper off in the region of the end face-side cutting step or on the transition section.

Depending on the intended use of the end mill cutter, a rasp geometry, which is created by means of the division of the cutting webs, which are spaced apart from one another by flutes, by means of the divider grooves running helically in the opposite direction, into cutting web segments, is not necessary. When the divider grooves taper off in the region of the end face-side cutting step or on the transition section, a quicker and thus more economic production of the end mill cutter is possible.

In an alternative advantageous embodiment, the divider grooves taper off in the region of the shaft-side cutting step.

The rasp geometry can thus also be formed on the shaft-side cutting step. The production process of the end mill cutter can be simplified when the divider grooves taper off in the region of the shaft-side cutting step, in particular advantageously run over the entire axial length of the shaft-side cutting step like the flutes.

In a preferred embodiment, the groove base of the divider grooves lies on a larger diameter than the groove base of the flutes.

Due to the fact that the function of the divider grooves is predominantly limited to a formation of the rasp geometry by dividing the cutting webs and the material removed from the main cutting edges of the cutting web segments is discharged via the flutes, the stability of the end mill cutter can be increased due to the fact that the groove base of the divider grooves lies on a larger diameter than the groove base of the flutes. Compared to divider grooves, the groove base of which lies on a smaller diameter, the core of the end mill cutter has a higher strength.

However, the groove base of the divider grooves can alternatively also lie on a same diameter as the groove base of the flutes.

When the groove base of the divider grooves lies on a same diameter as the groove base of the flutes, the production process or the formation of the flutes and of the divider grooves, respectively, can be simplified by means of a grinding wheel.

In a preferred embodiment, the cutting webs have cutting surfaces with negative cutting angles. The negative cutting angle is preferably smaller than or equal to 25°, in particular 19°.

The cutting angle is usually defined as the angle between a tool reference plane and the cutting surface. The negative cutting angle ensures that the end mill cutter does not cut the material to be removed, but peels or scrapes it off. It was determined that good surface qualities during the processing of layered composite materials, e.g., CRP materials, as well as during the removal of relatively soft insulating material from a metal wire, in particular hairpin wires, can be achieved by means of the cutting edge geometry according to the invention of the end mill cutter. During the milling of fiber reinforced layered composite materials, the negative cutting angle has the effect that the fibers contained in the layer composite are peeled off and are thus ripped out of the layer composite less easily, whereby a delamination of fibers or fiber protrusions on the milling edges is counteracted. During the stripping of wires, the negative cutting angle provides for a removal of the insulating material from the wire lying below the insulating layer, which protects the wire because the main cutting edges of the cutting web segments belonging to the cutting surfaces with negative cutting angle allows for a material removal, which can be metered technically more easily than cutting web segments with cutting surfaces with positive cutting angle.

The angle of twist of the divider grooves is preferably larger than the angle of twist of the flutes. Particularly good surface qualities result during the processing of layered composite materials as well as during the removal of insulating material from wires when the angle of twist of the flutes lies between 10° and 25°, in particular between 15° and 19°, and the angle of twist of the divider grooves lies between 25° and 40°, particular between 29° and 33°.

In a preferred embodiment, the cutting head of the end mill cutter is formed so as to cut on the end face.

Due to the end cutting edges, the end mill cutter is able to form counterbores in a workpiece by plunging in the end mill cutter in the direction of the axis of rotation.

The number of flutes is preferably smaller than the number of divider grooves. If the number of flutes is between 8 and 14, in particular 11, and the number of divider grooves is between 12 and 18, in particular 15, a very good compromise results between a simple and quick manufacture of the end mill cutter as well as a sufficiently large number of formed cutting web segments for removing material.

In a preferred embodiment, the cutting webs or the cutting web segments, respectively, have clearance surfaces.

Due to the clearance surfaces, the friction between the end mill cutter and the material to be processed or to be removed can be decreased and the cutting speed can be increased. The reduced friction leads to a smaller heat development and ultimately to a higher durability and longer service life.

The clearance surfaces are preferably angled. It is particularly advantageous when a first clearance angle of a first clearance surface section is between 8° and 12°, in particular 10°, and a second clearance angle of a second clearance angle section is between 10° and 15°, in particular 13°.

Compared to a clearance surface with constant clearance angle, a smoother transition can be attained by means of an angling of the clearance angle, for example through the first clearance surface section and second clearance surface section. The wedge angle of the cutting web segments is larger, whereby the stability of the cutting web segments improves. This contributes to a higher durability and longer service life.

In a preferred embodiment, the divider grooves are narrower than the flutes.

When, compared to the end face-side cutting edge segment corner, the cutting webs or the cutting web segments, respectively, have clearance surfaces, the main cutting edges of each cutting web segment running at an angle of twist, perform the majority of the material removal, so that the removed material accumulates predominantly in the main flutes and not in the divider grooves. The divider grooves, which are narrower compared to the flutes, mainly have the function of dividing the cutting webs of the end mill cutter into cutting web segments. The wider flutes can easily receive the removed material and preferably discharge it in the direction of the shaft.

Each cutting web segment advantageously has a main cutting edge, which extends from an end face-side cutting web segment corner all the way to a shaft-side cutting web segment corner, whereby a length of the main cutting edge measured in the direction of the flute is shorter than a length of the clearance surface measured in the direction of the divider groove.

The end mill cutter comprising the main cutting edges, which are relatively short in this design, comprising the relatively longer clearance surfaces acts as rasp and provides very good surface qualities in particular in response to a removal of insulating material from a wire.

In a preferred embodiment, the transition section has an angle of between 50° and 70°, preferably between 55° and 65°, in particular 60°, to an axis of rotation of the end mill cutter.

When the transition section has an angle of between 50° and 70°, preferably between 55° and 65°, in particular 60°, to an axis of rotation of the end mill cutter, a continuous and stable transition is created between the shaft-side cutting step and the end face-side cutting step. The angle of the transition section is preferably adapted to the geometry of the workpiece to be processed.

In a preferred embodiment, an end face-side divider groove surface forming the cutting web segment has a negative flank angle. The flank angle can lie between 5° and 25°, preferably between 10° and 20°, in particular be 13°.

Even if the main cutting edges of the cutting web segments, which each extend from an end face-side cutting web segment corner all the way to a shaft-side cutting web segment corner, perform the majority of the machining work and the removed material is mainly discharged via the flutes, the end face-side cutting web segment corner also generates a force on the workpiece to be processed, which has a different direction than a force generated by the main cutting edge, e.g. is directed perpendicular to the force generated by the main cutting edge. The end face-side cutting web segment corner can remove an-albeit very small-material quantity into the divider groove. In the same way as a negative cutting angle of the cutting surfaces, the negative flank angle, which lies between 5° and 25°, preferably between 10° and 20°, and which is in particular 13°, can contribute to attaining good surface qualities during the processing of layered composite materials, e.g., CRP materials, as well as during the removal of relatively soft insulating material from a metal wire.

The above-discussed and further features will be described in more detail below on the basis of the enclosed drawings using the example of two embodiments of an end mill cutter.

### BRIEF DESCRIPTION OF THE DRAWINGS

FIG. 1 shows a perspective view of an end mill cutter according to a first embodiment.

FIG. 2 shows a side view of an end mill cutter in a second embodiment.

FIG. 3 shows an enlarged side view of a cutting head of the end mill cutter of FIG. 2.

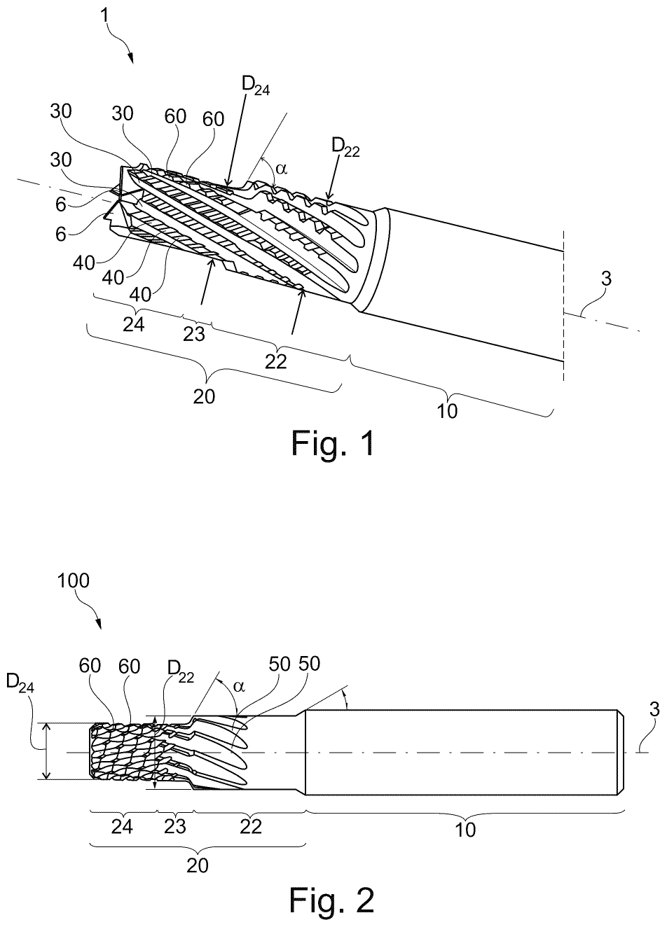

In FIGS. 1 to 3, identical reference numerals identify identical elements.

### DETAILED DESCRIPTION

### First Embodiment

FIG. 1 shows a first embodiment of an end mill cutter 1 according to the invention in the form of a combination tool, which is suitable for milling layered composite materials, e.g., fiber reinforced plastics (FRP), such as carbon fiber or glass fiber reinforced plastics (CRP/GRP), as well as for stripping wires. Further areas of application for the end mill cutter 1 are the processing of plastics as well as of easily machinable, soft metal materials, for example copper or aluminum.

FIG. 1 shows the end mill cutter 1, which can be rotated about an axis of rotation 3, in a perspective view. The end mill cutter 1 has a shaft 10 for clamping the end mill cutter 1 into a non-illustrated tool holder as well as a cutting head 20, which is divided into a shaft-side cutting step 22 with an outer diameter D22, a transition section 23 and an end face-side cutting step 24 with an outer diameter D24. The transition section 23 running at an angle α (for example) 60° to the axis of rotation 3, connects the shaft-side cutting step 22 to the end face-side cutting step 22. On its end face, the cutting head 20 carries several end cutting edges 6.

The cutting head 20 has a plurality of helically running cutting webs 50, which are spaced apart from one another by flutes 30. The cutting webs 50 are divided into several cutting web segments 60 comprising clearance surface by means of a plurality of divider grooves 40 running helically in the opposite direction. The flutes 30 as well as the divider grooves 40 each extend over the entire axial length of the cutting head 20, i.e., over the end face-side cutting step 24, the transition section 23 and the shaft-side cutting step 22. A cutting surface adjoining a circumferential cutting edge of the cutting web segments 60 is defined by a negative cutting angle.

In the first embodiment, the groove base of the divider grooves 40 lies on a larger diameter than the groove base of the flutes 30.

### Second Embodiment

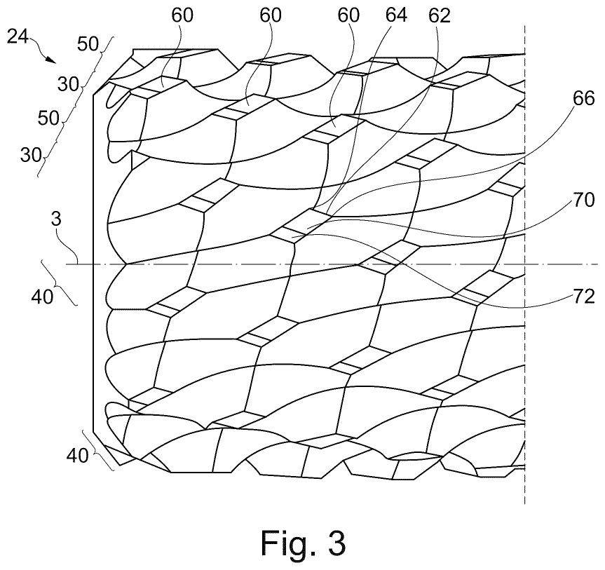

FIGS. 2 and 3 show a second embodiment of an end mill cutter 100 according to the invention in the form of a combination tool, which is suitable for milling layered composite materials, e.g., fiber reinforced plastics (FRP), such as carbon fiber or glass fiber reinforced plastics (CRP/GRP), as well as for stripping wires. Further areas of application for the end mill cutter 100 are the processing of plastics as well as of easily machinable, soft metal materials, for example copper or aluminum.

On the one hand, the end mill cutter 100 differs from the end mill cutter 1 in that it does not have any front cutting edges. On the other hand, the divider grooves 40, viewed axially, extend only into an end face-side front region of the shaft-side cutting step 22. The rasp geometry in the case of the end mill cutter 100 is thus formed only on the end face-side cutting step 24 and the transition section 23. The cutting webs 50 on the shaft-side cutting step 22 are not continuous and are not divided into cutting web segments 60. Lastly, the groove base of the divider grooves 40 lies on the same diameter as the groove base of the flutes 30.

The circumferentially cutting cutting webs 50 or the circumferentially cutting cutting web segments 60, respectively, have angled clearance surfaces on their backs. As illustrated in FIG. 3, each clearance surface has a first clearance surface section 70 with a first clearance angle and a second clearance surface section 72 with a second clearance angle. Due to the formation of the clearance surfaces on the cutting webs 50 or the cutting web segments 60, respectively, a main cutting edge 62, which extends from an end face-side cutting web segment corner 64 all the way to a shaft-side cutting web segment corner 66, is created on each cutting web segment 60.

A cutting surface adjoining the main cutting edge 62 merges into a flute 30, which leads in the direction of rotation. The cutting surface is defined by a negative cutting angle. The groove base of the flutes 30 is rounded and has a radius. A groove base of the flutes 30 lies on a diameter, which, in the second embodiment, corresponds to the diameter, on which the groove base of the divider grooves 40 lies. The groove base of the divider grooves 40 is likewise rounded and has a radius, which is smaller than the radius of the groove base of the flutes 30.

Like the end mill cutter, 1, the end mill cutter 100 is a right-turning tool. The flutes 30 or the cutting webs 50, respectively, are twisted to the right, so that the main cutting edges 62 of the cutting web segments 60 exert a force on the workpiece to be machined, which conveys the removed material, i.e., chips or insulating material, in the direction of the shaft 10. The divider grooves 40 are twisted to the left, whereby an absolute value of the angle of twist of the divider grooves 40 relative to the axis of rotation 3 is larger than an absolute value of the angle of twist of the flutes 30 relative to the axis of rotation 3. Lastly, the divider grooves 40 are narrower than the flutes 30, viewed in the direction of rotation. Due to their relatively large width and the groove base with relatively large radius, the flutes 30 have a sufficiently large volume for discharging the material removed from the main cutting edges 62.

In contrast to the end mill cutter 100 shown in FIGS. 2 and 3, the end face-side cutting step 24 can also be formed so as to cut on the end face in a manner, which is known per se to the person of skill in the art.

### LIST OF REFERENCE NUMERALS

α angle
D22 outer diameter
D24 outer diameter
1 end mill cutter
3 axis of rotation
4 direction of rotation
6 end cutting edge
10 shaft
20 cutting head
22 shaft-side cutting step
23 transition section
24 end face-side cutting step
30 flute
40 divider groove
50 cutting web
60 cutting web segment
62 main cutting edge
64 end face-side cutting web segment corner
66 shaft-side cutting web segment corner
70 first clearance surface section
72 second clearance surface section
100 end mill cutter

What is claimed is:

1. An end mill cutter (1; 100), comprising:
a shaft (10); and
a cutting head (20) with a number of helically running cutting webs (50),
wherein the helically running cutting webs (50) are spaced apart from one another by flutes (30),
wherein the cutting webs (50) are divided into cutting web segments (60) at least over a portion of their length by a number of divider grooves (40) running helically in a direction opposite the cutting webs (50), and
wherein the cutting head (20) is divided into
a shaft-side cutting step (22) and
an end face-side cutting step (24) adjoining the shaft-side cutting step (22)
via a transition section (23) with a cutting diameter (D24), which is smaller than a cutting diameter (D22) of the shaft-side cutting step (22).

2. The end mill cutter according to claim 1,
wherein the divider grooves (40) taper off in a region of the end face-side cutting step (24) or at the transition section (23).

3. The end mill cutter (1; 100) according to claim 1,
wherein the divider grooves (40) taper off in a region of the shaft-side cutting step.

4. The end mill cutter (1) according to claim 1,
wherein a groove base of the divider grooves (40) lies on a larger diameter than a groove base of the flutes (30).

5. The end mill cutter (1; 100) according to claim 1,
wherein the cutting webs (50) have cutting surfaces with negative cutting angles.

6. The end mill cutter (1; 100) according to claim 1,
wherein an angle of twist of the divider grooves (40) is larger than an angle of twist of the flutes (30).

7. The end mill cutter (1) according to claim 1,
wherein the cutting head (20) is formed so as to cut on an end face.

8. The end mill cutter (1; 100) according to claim 1,
wherein the number of flutes (30) is smaller than the number of divider grooves (40).

9. The end mill cutter (1; 100) according to claim 1,
wherein the cutting webs (50) have clearance surfaces.

10. The end mill cutter (1; 100) according to claim 9,
wherein the clearance surfaces are angled.

11. The end mill cutter (1; 100) according to claim 1,
wherein the divider grooves (40) are narrower than the flutes (30).

12. The end mill cutter (1; 100) according to claim 9,
wherein each cutting web segment (60) has a main cutting edge (62), which extends from an end face-side cutting web segment corner (64) all the way to a shaft-side cutting web segment corner (66), whereby a length of the main cutting edge (62) measured in the direction of the flute (30) is shorter than a length of the clearance surface measured in the direction of the divider groove (40).

13. The end mill cutter (1; 100) according to claim 1,
wherein the transition section (23) has an angle between 55° and 65° to an axis of rotation (3) of the end mill cutter.

14. The end mill cutter (1; 100) according to claim 1,
wherein an end face-side divider groove surface forming the cutting web segment (60) has a negative flank angle.
